(19) United States
(12) Patent Application Publication
(10) Pub. No.: US 2007/0099626 A1
(43) Pub. Date: May 3, 2007

(54) Tracking system and method

(75) Inventors: Micah T. Lawrence, Largo, FL (US); John O. Wilson, Largo, FL (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/262,599

(22) Filed: Oct. 31, 2005

(51) Int. Cl. H04Q 7/20

(52) U.S. Cl. 455/456.1; 701/207

(57) ABSTRACT

A system and method for determining and communicating the precise location of an individual and/or a motor vehicle in real-time is disclosed. As an example, a tracking system is disclosed that includes a Global Positioning System (GPS) receiver, a cellular phone, and a processing unit. The GPS receiver, cellular phone and processing unit are arranged as a single, compact tracking unit. The processing unit receives precise location information (e.g., latitudinal and longitudinal coordinates) for the tracking unit from the GPS receiver. A cellular phone capable of receiving text messages (e.g., and/or voice messages) can be used to call the cellular phone of the tracking unit, which responds (e.g., to an authenticated call) by transmitting a text message (e.g., or synthesized voice message) including the precise coordinates of the tracking unit. Thus, either with or without the knowledge of the individual carrying the tracking unit or driving the motor vehicle containing the tracking unit, the system is capable of providing the exact location of the individual and/or motor vehicle to another at any point in time.

### FIELD OF THE INVENTION

The present invention relates generally to the position determination field, and more particularly, but not exclusively, to a system and method for determining and communicating the precise location of an individual and/or a vehicle.

### BACKGROUND OF THE INVENTION

There is a substantive, continuing need to improve the safety and security of individuals. However, there are a number of problems related to individual safety and security that arise as a result of not knowing the precise location of individuals and/or their motor vehicles at particular points in time. Notably, if a person is lost, or stranded with a motor vehicle at an unknown location, or a motor vehicle is stolen or car-jacked, then an acquaintance or the family of that person, the owner of that vehicle, and/or the police would want to know the precise location of that person or vehicle as quickly as possible. Admittedly, within the last five years, cellular phone use has become as common as owning a television set. Consequently, if an average person is stranded but knows their precise location (e.g., intersection of K Street and Fifth Avenue), then that person can relay that information to someone else with a cellular phone. However, a significant problem in this regard is that if the person is lost or the motor vehicle is stolen, then a cellular phone is not particularly useful in ascertaining the location of that person or vehicle. Therefore, it would be advantageous to have a system and method that can determine and communicate to another the precise location of an individual and/or motor vehicle in real-time, which is also relatively easy to implement by an average person. As described in detail below, the present invention provides such a system and method, which resolves the existing individual and/or vehicle location determination and communication problems and similar other problems.

### SUMMARY OF THE INVENTION

The present invention provides a system and method for determining and communicating the precise location of an individual and/or a motor vehicle in real-time. In accordance with a preferred embodiment of the present invention, a tracking system is provided that includes a Global Positioning System (GPS) receiver, a cellular phone, and a processing unit. The GPS receiver, cellular phone and processing unit are arranged as a single, compact tracking unit. The processing unit receives precise location information (e.g., latitudinal and longitudinal coordinates) for the tracking unit from the GPS receiver. A cellular phone capable of receiving text messages (e.g., and/or voice messages) can be used to call the cellular phone of the tracking unit, which responds (e.g., to an authenticated call) by transmitting a text message (e.g., or synthesized voice message) including the precise coordinates of the tracking unit. Thus, either with or without the knowledge of the individual carrying the tracking unit or driving the motor vehicle containing the tracking unit, the present invention is capable of providing the exact location of the individual and/or motor vehicle to another at any point in time.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a block diagram of an example system for determining and communicating the location of an individual and/or vehicle, which can be used to implement a preferred embodiment of the present invention; and

FIGS. 2A and 2B depict related flow charts showing an exemplary method for determining and communicating to another the precise location of an individual and/or vehicle in real-time, in accordance with a preferred embodiment of the present invention.

### DETAILED DESCRIPTION OF PREFERRED EMBODIMENT

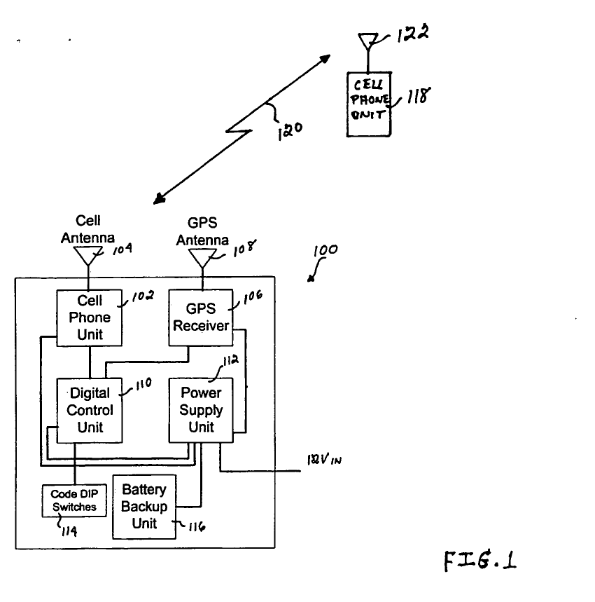

With reference now to the figures, FIG. 1 depicts a block diagram of an example system 100 for determining and communicating the location of an individual and/or vehicle, which can be used to implement a preferred embodiment of the present invention. For this example embodiment, system 100 includes a cellular telephone unit 102 coupled to a cellular telephone antenna 104 for transmitting and receiving calls (e.g., via a commercially available cellular network). However, although unit 102 is disclosed herein as a cellular telephone for this example embodiment, the present invention is not intended to be so limited and can include within its scope of coverage any suitable type of mobile or wireless device that can receive and recognize a plurality of alphanumeric symbols (e.g., keyed-in numbers) and/or vocal commands (e.g., spoken numbers), and also transmit a plurality of text messages and/or predetermined voice messages (e.g., “current location is such and such latitude, such and such longitude”, etc.). Also, although system 100 is described herein primarily in the context of determining and communicating the location of an individual or motor vehicle, the present invention can include within its scope of coverage other types of vehicles, such as, for example, boats, aircraft, trains, etc.

For this example embodiment, system 100 also includes a GPS receiver unit 106 coupled to a GPS antenna 108 for receiving signals continuously from a plurality of on-orbit satellite transmitters, and converting those signals to coordinate data (e.g., latitude and longitude) that describes the precise location of system 100 at any point in time. Notably, although unit 106 is described herein as a GPS receiver for this example embodiment, the present invention is not intended to be so limited and can include within its scope of coverage any suitable type of navigation receiver that can produce location information that is substantially as precise as GPS-derived location information. In any event, for this example embodiment, an output of GPS receiver unit 106 is coupled to an input of a digital control unit 110. Also, cellular telephone unit 102 is coupled to digital control unit 110 so that data (e.g., control data, received data, text message data, etc.) can be transferred to/from cellular telephone unit 102 from/to digital control unit 110. As such, digital control unit 110 can be implemented with a suitable digital processor and/or control unit such as, for example, a microprocessor or microcontroller disposed on a semiconductor chip. Additionally, a DIP switch unit 114 is connected to an input of digital control unit 110, so that a user of system 100 can set a plurality of the switches of DIP switch unit 114 in a combination that forms an authentication or security code that can be recognized and stored by digital control unit 110 in an associated memory device.

For this example embodiment, cellular telephone unit 102, GPS receiver unit 106, and digital control unit 110 are each connected to a power supply unit 112. Power supply unit 112 is electrically connected to an external power source (e.g., 12V battery of a host motor vehicle, or similar external power source) and a battery backup unit 116. For example, battery backup unit 116 can include a lithium-ion battery that can provide low power levels for components of system 100 over extended periods of time. Thus, power supply unit 112 can function as a regulator/switching device, which supplies power at suitable levels to cellular telephone unit 102, GPS receiver unit 106 and digital control unit 110 from the external power source (e.g., motor vehicle battery) whenever the external power is available, or from battery backup unit 116. Power supply unit 112 can also function as a battery charger, which recharges battery backup unit 116 (e.g., a conventional rechargeable battery) while the external power is available, so that system 100 can operate, if necessary, as a standalone unit. In other words, if system 100 is disconnected from the external power source, then system 100 can continue to operate (e.g., at reduced power levels) as a standalone unit for an extended period of time. As such, system 100 can be maintained for an extended period in a standby mode at reduced power, and digital control unit 110 will not enable the transmitter of cellular telephone unit 102 until, for example, an authenticated call is received by cellular telephone unit 102 and a reply message (e.g., including location information) is to be transmitted.

For this example embodiment, FIG. 1 also shows a cellular telephone unit 118, which can be used to communicate with cellular telephone unit 102 via a radio link 120 (e.g., cellular network) and antennas 104 and 122. Notably, although units 102 and 118 are described as cellular telephones for this embodiment, the present invention is not intended to be so limited and can also include other types of wireless communication devices (e.g., wireless radiotelephones, mobile radios, etc.) for two-way communications. As such, it is preferable that the communication device used for unit 118 is a mobile (as opposed to a fixed location) two-way communication device. However, although less preferable, for another embodiment, a fixed, land-line telephone may also be used for unit 118 in order for a user to call and communicate with cellular telephone unit 102.

Essentially, in operation for this example embodiment, a user (e.g., operator, purchaser, owner, etc.) of system 100 initially contacts a cellular telephone service provider and receives a unique, non-published (private) telephone number assigned to cellular telephone unit 102. The user (or telephone service provider) then enters a security/authentication code into system 100 by setting a suitable combination of switches in DIP switch unit 114. The switch settings (security/authentication code) are received by digital control unit 110, which stores the code data in an associated memory device. Notably, it should be understood that although DIP switch unit 114 is used for entering a security code in this example embodiment, the present invention is not intended to be so limited, and can include any other suitable technique for entering and storing a security/authentication code in system 100 (e.g., user connects a personal computer to system 100 via a USB connector and enters a security code to digital control unit 110 via the personal computer's keyboard, etc.).

In any event, the user may connect system 100 to an external power source (e.g., host motor vehicle battery) or operate system 100 on internal power as a standalone unit (e.g., personal carry). In order to determine the precise location of system 100 (and the host vehicle, person carrying the unit, etc.), a user (e.g., using communication unit 118) calls the telephone number assigned to cellular telephone unit 102. At this point, digital control unit 110 instructs cellular telephone unit 102 to enable the transmitter and transmit a reply (e.g., audible beep) to prompt the caller to reply with a valid security or authentication code (e.g., keyed-in number sequence). Only if digital control unit 110 recognizes the keyed-in number sequence as a valid code (e.g., matches switch settings in DIP switch unit 114), then digital control unit 110 retrieves from local memory the most current location information from GPS receiver unit 106, formulates a text message including the most current location information, and instructs cellular telephone unit 102 to transmit the text message to the authenticated caller (e.g., via radio link 120 to communication unit 118). If a movement history is desired, system 100 can also include in the text message suitable information about past locations (e.g., the past 5 locations where system 100 did not move for a predetermined interval of time). Therefore, except for the slight delay in placing the call, system 100 can, in real-time, provide for an authenticated (e.g., mobile) caller the precise location (and movement history) of system 100, a host vehicle for system 100, and/or an individual carrying system 100. If desired, unit 118 can also be implemented with a display suitable for showing a representative map and the current location of system 100 on that map (e.g., unit 118 can include graphics software to generate such a map, analyze the coordinate data received from system 100, and thus display the location of system 100 on that map).

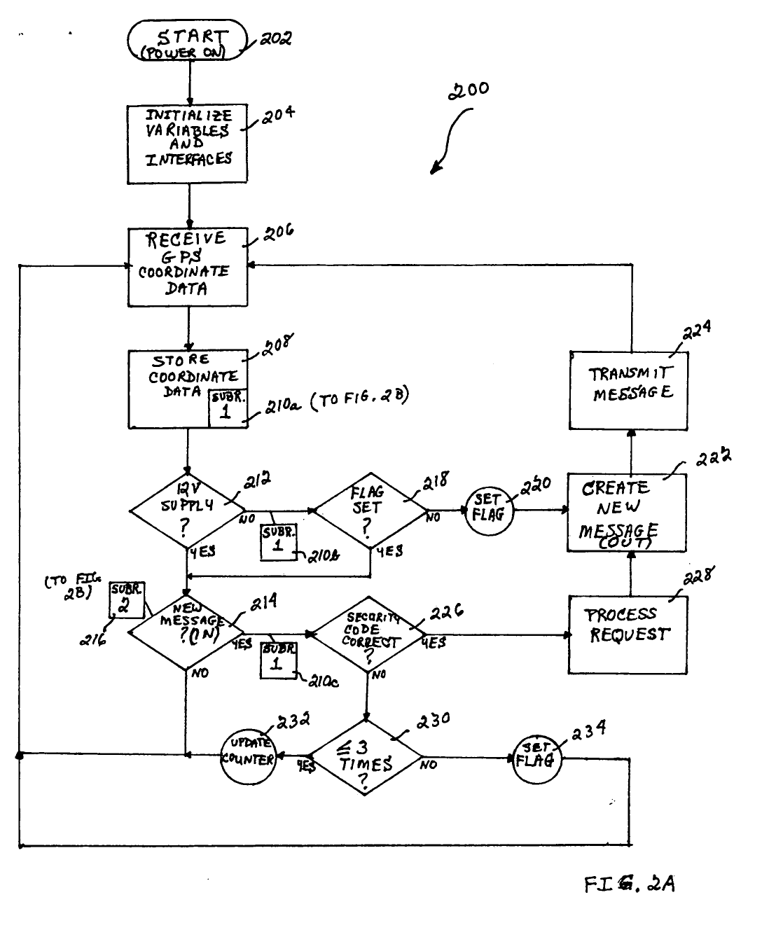

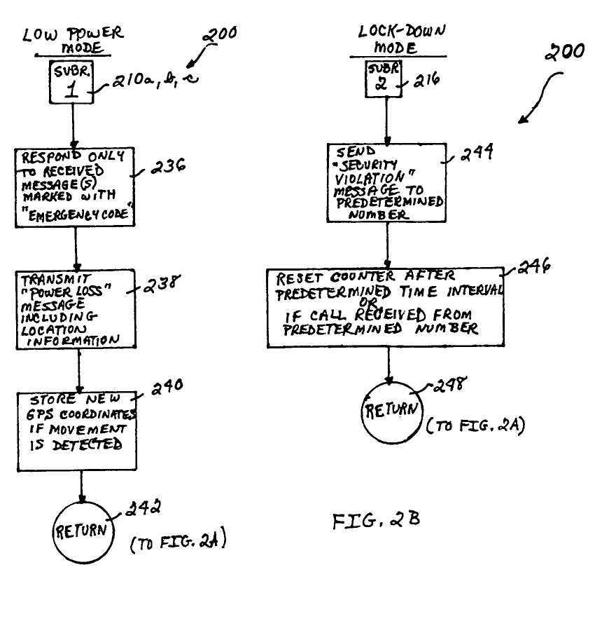

FIGS. 2A and 2B depict related flow charts showing an exemplary method 200 for determining and communicating to another the precise location of an individual and/or vehicle in real-time, in accordance with a preferred embodiment of the present invention. For this example embodiment, method 200 represents an algorithm that can be implemented as software instructions executed by a microprocessor or microcontroller, such as, for example, digital control unit 110 in FIG. 1. As such, referring to FIGS. 1, 2A and 2B for this example, system 100 is powered on (step 202 of FIG. 2A). Next, digital control unit 110 begins to initialize the operation of system 100, by retrieving initial operating environment variables from read-only memory (e.g., EEPROM) and storing that data in system memory (RAM) for initial execution. Using the stored environment variables data, digital control unit 110 then initializes the peripheral interfaces between each of the units (e.g., 102-116) in system 100 (step 204). Next, digital control unit 110 receives new coordinate data from GPS receiver unit 106 (step 206). Digital control unit 110 then stores the received GPS coordinate data (e.g., along with a time stamp) in system memory (step 208). Next, for this example embodiment, if system 100 is operating in a “low power mode” (e.g., not yet determined at this point), digital control unit 110 stores the location data only when movement of system 100 is detected. Otherwise, for example, the location data can be stored in memory at fixed intervals and retrieved at any time. As such, an operation to determine whether system 100 is in a “low power mode” involves a step of checking a flag that is set when the “low power mode” subroutine is executed, as illustrated by element 220 in FIG. 2A and elements 210a, b, c in FIGS. 2A and 2B.

Next, digital control unit 110 determines by a suitable signal received from power supply unit 112 whether or not external power (e.g., 12V from a motor vehicle) is applied (step 212). If so, then digital control unit 110 instructs power supply unit 112 to couple the (regulated) external power to battery backup unit 116 in order to maintain a suitable charge on the internal battery. Notably, for this example embodiment, digital control unit 110 continuously monitors power supply unit 112 to determine whether or not the external power is applied.

If power supply unit 112 experiences a voltage loss condition, an immediate transition to battery backup power is made by the hardware. Additionally, a suitable signal is set (e.g., signal associated with the voltage loss condition), which is monitored by digital control unit 110. Thus, if (at step 212) digital control unit 110 determines that the external power is not applied or has failed, then (at element 210b) the “low power mode” flag is verified. If this flag is already set, the power loss condition was previously processed, so the flow continues back to step 214 of FIG. 2A. If this flag is not set, then flow proceeds to the “low power mode” subroutine 1 (e.g., beginning with element 220 in FIG. 2A). This procedure sets the necessary flags that are checked in other parts of the main routine in FIG. 2A, and then digital control unit 110 begins execution of the steps in subroutine 1 (elements 210a, b, c in FIG. 2B).

For data security, digital control unit 110 immediately copies pertinent data from the volatile system memory (e.g., RAM) to a suitable internal, non-volatile memory device. Next, to conserve power, digital control unit 110 responds only to request messages for location information received by cellular telephone unit 102, which are accompanied by a predetermined “emergency code” (step 236). This procedure is again verified by checking a flag that is set during execution of the “low power mode” subroutine. For this example embodiment, if system 100 is operating in the “low power mode”, only emergency location request messages will be answered. For example, digital control unit 110 can continuously monitor cellular telephone unit 102 to determine whether or not cellular telephone unit 102 has received a location request message marked with an appropriate “emergency code”. Until such an “emergency” message is received, system 100 can operate in a low power, standby mode.

In any event, for this example embodiment, digital control unit 110 creates a message at step 222 of FIG. 2A (e.g., corresponding to step 238 in subroutine 1 of FIG. 2B), including a suitable “power loss” statement along with the current location information derived from GPS receiver unit 106 (step 238). The “power loss” message is transmitted via cellular telephone unit 102 and antenna 104 (step 224). Subsequently, this “power loss” message is created and transmitted only in response to a location request received and accompanied by the appropriate “emergency code”.

Returning to step 214 for this example embodiment, digital control unit 110 determines whether or not a new location request message has been received by cellular telephone unit 102 (step 214). If not, then flow returns to step 206. However, if (at step 214) a new location request message is received by cellular telephone unit 102, then digital control unit 110 interrupts the current operational mode and issues a “decode” command, which prompts system 100 to await the receipt (e.g., via cellular phone unit 102) of a security code (e.g., entered by the caller). Additionally, the “low power mode” flag is checked. If this flag is set, further message processing will continue only if the request message is marked with an “emergency code”.

Next, digital control unit 110 decodes the portion of the request message that should contain the security code. If such a code is received (e.g., from the caller), digital control unit 110 then determines whether or not the received code is correct, by matching it with the code sequence from the switch settings in DIP switch unit 114 (step 226). If the received code is incorrect (e.g., does not match the switch settings), then digital control unit 110 determines whether or not a predetermined number (e.g., 3) of incorrect codes have been received (step 230). If a correct code is received from the caller within the predetermined number of attempts, then digital control unit 110 updates and/or resets a (security code) counter (step 232), and the flow returns to step 206.

Returning to step 226, if digital control unit 110 determines that a correct authentication/security code has been received within the allotted number of attempts, digital control unit 110 enables the transmitter stage of cellular phone unit 102. Digital control unit 110 then determines whether or not a valid command (e.g., “send position coordinates”) has been received via cellular phone unit 102. If so, then digital control unit 110 processes the message request (step 228), by retrieving stored position coordinate data (e.g., depending on the power mode of system 100, either from RAM or nonvolatile memory), and constructing a suitable text response message including the retrieved coordinate data (step 222). Alternatively, for example, digital control unit 110 can construct a suitable text message or voice message including the position coordinate data using a digital voice synthesizer. Digital control unit 110 then forwards the message to cellular telephone unit 102, which transmits the message for receipt by the caller's phone (step 224). Next, for this example, in order to conserve power if system 100 is operating in a “low power mode, digital control unit 110 disables the transmitter stage of cellular telephone unit 102, and flow returns to step 206.

Returning to step 230 of FIG. 2A, if digital control unit 110 determines that more than the predetermined number (e.g., 3) of security/authentication code mismatches have occurred, then digital control unit 110 sets a “locked-down mode” flag (step 234), and (at element 216b) executes the “locked-down mode” subroutine. Thus, referring to element 216 in FIG. 2B, digital control unit 110 creates a suitable “security violation” report message, and sends that message (via cellular telephone unit 102) to a predetermined phone (step 244). For example, the predetermined phone can be the home phone for a person accompanying system 100. Notably, if system 100 is also operating in the “low power mode”, digital control unit 110 can enable the transmitter stage of cellular telephone unit 102 solely for the purpose of sending the “security violation” message. In any event, for a predetermined interval of time (e.g., 30 minutes), digital control unit 110 can deny (e.g., not respond to) incoming location request messages. After the predetermined time interval has expired, or for example, if a valid call is received from the predetermined (home) phone, digital control unit 110 resets the counter associated with the security code (step 246). The “locked-down mode” subroutine is then terminated (step 248), and flow returns to step 206 in FIG. 2A.

It is important to note that while the present invention has been described in the context of a fully functioning position determination and communication system and method, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular position determination and communication system and method.

The description of the present invention has been presented for purposes of illustration and description, and is not intended to be exhaustive or limited to the invention in the form disclosed. Many modifications and variations will be apparent to those of ordinary skill in the art. These embodiments were chosen and described in order to best explain the principles of the invention, the practical application, and to enable others of ordinary skill in the art to understand the invention for various embodiments with various modifications as are suited to the particular use contemplated.

1. A system for determining and communicating the position of an entity, comprising:
a wireless communication unit;
a navigation receiver unit; and
a processing unit coupled to said wireless communication unit and said navigation receiver unit, said processing unit operable to:
receive position data for said entity from said navigation receiver unit;
receive a position request from said wireless communication unit;
responsive to the position request, send an authentication request to said wireless communication unit;
receive a reply from said wireless communication unit, the reply including an authentication code;
compare the authentication code with a predetermined code;
determine if the authentication code is substantially equal to the predetermined code; and
if the authentication code is substantially equal to the predetermined code, send said position data for said entity to said wireless communication unit for transmission responsive to said position request.

2. The system of claim 1, wherein said system comprises a tracking system.

3. The system of claim 1, wherein said wireless communication unit comprises a wireless radiotelephone.

4. The system of claim 1, wherein said wireless communication unit comprises a cellular telephone.

5. The system of claim 1, wherein said navigation receiver unit comprises a satellite navigation receiver.

6. The system of claim 1, wherein said navigation receiver unit comprises a GPS receiver.

7. The system of claim 1, wherein said processing unit comprises at least one of a digital control unit, microprocessor or microcontroller.

8. The system of claim 1, wherein said entity comprises at least one of a person, vehicle, boat or aircraft.

9. The system of claim 1, wherein said position data comprises latitude and longitude coordinate data.

10. The system of claim 1, further comprising:
means, coupled to said processing unit, for entering a security code and determining if said position request is valid.

11. The system of claim 1, further comprising:
means, coupled to said processing unit, for determining if said position request is valid, and if not, operating the system in a locked-down mode.

12. The system of claim 1, further comprising:
means, coupled to said processing unit, said wireless communication unit and said navigation receiver unit, for maintaining power for said system.

13. The system of claim 1, further comprising:
means, coupled to said processing unit, for determining if external power is applied to the system, and if not, operating the system in a low power mode.

14. The system of claim 1, wherein said position request is originated at a mobile communication unit.

15. The system of claim 1, further comprising:
means for displaying a map and said position data on said map

16. A tracking system, comprising:
means for receiving and transmitting at least one message associated with a position of said system;
means for determining said position of said system; and
means for receiving position data for said system, receiving a request message for said position data, sending an authentication request, receiving a reply including an authentication code, comparing the authentication code with a predetermined code, determining if the authentication code is substantially equal to the predetermined code, and transmitting said at least one message responsive to said request, if the authentication code is substantially equal to the predetermined code.

17. The tracking system of claim 16, wherein said means for receiving and transmitting comprises a cellular telephone.

18. The tracking system of claim 16, wherein said means for determining said position of said system comprises a GPS receiver.

19. The tracking system of claim 16, wherein said means for receiving position data comprises a digital control unit.

20. A method for determining and communicating the position of an entity, comprising the steps of:
receiving position data for said entity from a navigation receiver unit;
receiving a position request from a wireless communication unit;
responsive to the position request, sending an authentication request to the wireless communication unit;
receiving a reply from the wireless communication unit, the reply including an authentication code;
comparing the authentication code with a predetermined code;
determining if the authentication code is substantially equal to the predetermined code;
sending said position data for said entity to said wireless communication unit if the authentication code is substantially equal to the predetermined code; and
said wireless communication unit transmitting said position data responsive to said position request if the authentication code is substantially equal to the predetermined code.

21. The method of claim 20,
wherein the predetermined code comprises a security code.

22. The method of claim 20, further comprising the steps of:
coupling internal power to said wireless communication unit and said navigation receiver unit, if external power is not coupled to at least one of said wireless communication unit and said navigation receiver unit.

23. A computer program product, comprising:
a computer-usable medium having computer-readable code embodied therein for configuring a computer processor, the computer program product comprising:
a first executable computer-readable code configured to cause a computer processor to receive position data for an entity from a navigation receiver unit;
a second executable computer-readable code configured to cause a computer processor to receive a position request from a wireless communication unit;
a third executable computer-readable code configured to cause a computer processor to send an authentication request to the wireless communication unit;
a fourth executable computer-readable code configured to cause a computer processor to receive a reply from the wireless communication unit, the reply including an authentication code;
a fifth executable computer-readable code configured to cause a computer processor to compare the authentication code to a predetermined code;
a sixth executable computer-readable code configured to cause a computer processor to determine if the authentication code is substantially equal to the predetermined code;
a seventh executable computer-readable code configured to cause a computer processor to send said position data for said entity to said wireless communication unit if the authentication code is substantially equal to the predetermined code; and
an eighth executable computer-readable code configured to cause a computer processor to enable said wireless communication unit to transmit said position data responsive to said position request if the authentication code is substantially equal to the predetermined code.

24. The computer program product of claim 23, further comprising:
a ninth executable computer-readable code configured to cause a computer processor to store a security code, wherein the security code comprises the predetermined code.
